(19) United States
(12) Patent Application Publication
(10) Pub. No.: US 2025/0299843 A1
(43) Pub. Date: Sep. 25, 2025

(54) GAS ANALYSIS SYSTEMS, METHODS, AND REACTORS

(71) Applicant: Group14 Technologies, Inc., Woodinville, WA (US)

(72) Inventors: Rajankumar Patel, Lehi, UT (US); Nathan Waddill, Moses Lake, WA (US); Alex Churchill, Blacksburg, VA (US); Sherwood Baker, Moses Lake, WA (US)

(21) Appl. No.: 19/076,202

(22) Filed: Mar. 11, 2025

Related U.S. Application Data
(60) Provisional application No. 63/567,338, filed on Mar. 19, 2024.

(51) Int. Cl. G21C 17/028

(52) U.S. Cl. CPC G21C 17/028

(57) ABSTRACT

Methods, systems, and reactors for chemical vapor infiltration reaction endpoint determination. A system includes a user interface device to enter an inert gas quantity inputted to a reactor, an output device, a hydrogen sensor configured to generate a hydrogen concentration value, a total density sensor configured to generate a total density value, and a processor coupled to the user interface device, the output device, the hydrogen sensor, and the total density sensor. The processor receives the inert gas quantity, the hydrogen concentration value, and the total density value, determines a silicon absorption value based on the received values, generates a signal in response to the silicon absorption value being at or above a predetermined threshold value, and sends the generated signal to the output device. The output device outputs an indication in response to receiving the signal.

### CROSS-REFERENCE TO RELATED APPLICATION

This application claims the benefit of priority to U.S. Provisional Application No. 63/567,338, filed Mar. 19, 2024, the entire contents of which is incorporated herein by reference.

### BACKGROUND

Currently Fourier transform—infrared (FT-IR) spectroscopy analysis is used to analyze completion of certain composite reactions. However, FT-IR spectroscopy is very sensitive thus requiring a lot of hands-on work and maintenance. In very dynamic composite reactions, the FT-IR spectroscopy device breaks down easily or produces inaccurate results.

### BRIEF SUMMARY

Various disclosed embodiments include illustrative systems, methods, and reactors for creating carbon particles and electrochemical modifier infiltrated carbon particles and measuring completion of the created composite material. In certain embodiments the electrochemical modifier comprises at least one Group 14 element (e.g., carbon or silicon).

In an illustrative embodiment, a method includes receiving a value of a quantity of an inert gas sent to a reactor, receiving a hydrogen concentration value sensed at a first exhaust of the reactor, receiving a total density value sensed at a second exhaust of the reactor, determining a silicon absorption value based on the value of the quantity of the inert gas, the hydrogen concentration value, and the total density value, and outputting a process completion indication in response to the silicon absorption value being at or above a predetermined threshold value.

In another illustrative embodiment, a system includes a user interface device configured to allow a user to enter a value of a quantity of an inert gas an inert gas quantity inputted to a reactor, an output device, a hydrogen sensor configured to generate a hydrogen concentration value sensed at a first exhaust of the reactor, a total density sensor configured to generate a total density value sensed at a second exhaust of the reactor, and a processor coupled to the user interface device, the output device, the hydrogen sensor, and the total density sensor. The processor is configured to receive the value of the quantity of the inert gas, the hydrogen concentration value, and the total density value, determine a silicon absorption value based on the value of the quantity of the inert gas, the hydrogen concentration value, and the total density value, generate a signal in response to the silicon absorption value being at or above a predetermined threshold value, and send the generated signal to the output device. The output device outputs an indication in response to receiving the signal.

In still another illustrative embodiment, a reactor includes a chamber including an exhaust, the chamber is configured to: receive an inert gas, silane, and a porous carbon material and heat the received the inert gas, the silane, and the porous carbon material, a user interface device configured to allow a user to enter an inert gas quantity inputted to the chamber, an output device, a hydrogen sensor configured to generate a hydrogen concentration value sensed at the exhaust of the chamber, a total density sensor configured to generate a total density value sensed at a second exhaust of the chamber, and a processor coupled to the user interface device, the output device, the hydrogen sensor, and the total density sensor, the processor being configured to: receive the entered inert gas quantity, the hydrogen concentration value, and the total density value, determine a silicon absorption value based on the received inert gas quantity, the hydrogen concentration value, and the total density value, generate a signal in response to the silicon absorption value being at or above a predetermined threshold value, and sending the generated signal to the output device. The output device outputs an indication in response to receiving the signal.

### BRIEF DESCRIPTION OF THE DRAWINGS

FIG. 1 is a block diagram of material processing system formed in accordance with an embodiment of the present invention.

FIG. 2 is a graph of density calculations formed in accordance with an embodiment of the present invention.

FIG. 3 is a graphical user interface formed in accordance with an embodiment of the present invention.

FIG. 4 is a spreadsheet formed in accordance with an embodiment of the present invention.

FIG. 5 is an illustration of exemplary stripchart data formed in accordance with an embodiment of the present invention.

FIG. 6 is an illustration of exemplary formed in accordance with an embodiment of the present invention.

FIG. 7 is a flow diagram formed in accordance with an embodiment of the present invention.

### DETAILED DESCRIPTION

In the following description, certain specific details are set forth in order to provide a thorough understanding of various embodiments. However, one skilled in the art will understand that the disclosure may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed disclosure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

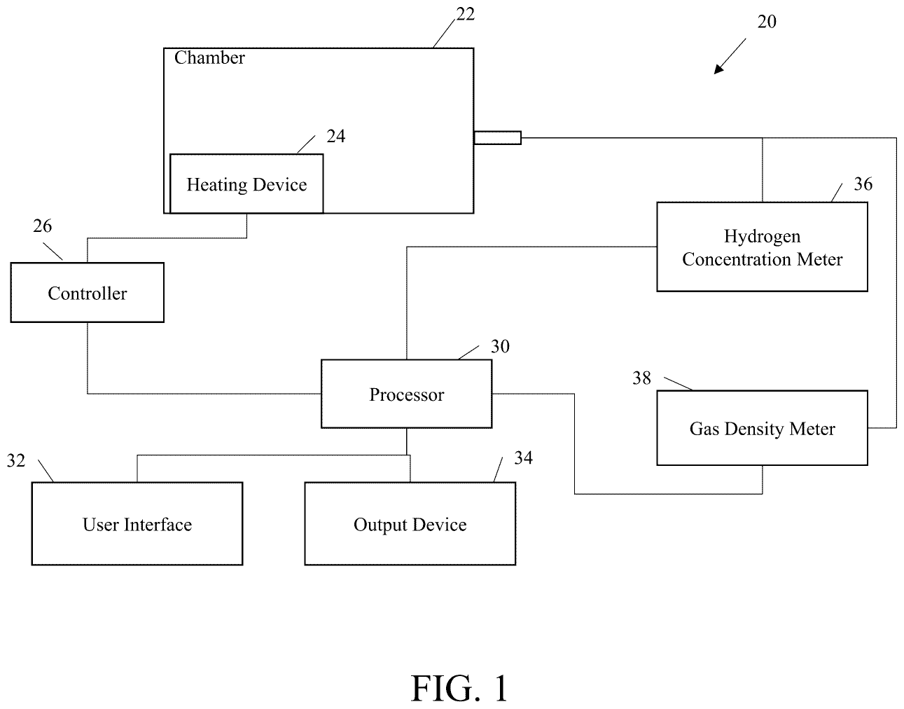

In various embodiments, as shown in FIG. 1, a system 20 is shown for producing a carbon material having an electrochemical modifier. The system 20 includes a porous carbon production system 22, a double fines removal system 24, and a chemical vapor infiltration system 26.

### A. Porous Scaffold Materials

For the purposes of embodiments of the current disclosure, a porous scaffold may be used, into which one or more electrochemical modifier (e.g., lithium or silicon) is to be impregnated. In this context, the porous scaffold can comprise various materials. In some embodiments the porous scaffold material primarily comprises carbon, for example hard carbon. Other allotropes of carbon are also envisioned in other embodiments, for example, graphite, amorphous carbon, diamond, C60, carbon nanotubes (e.g., single and/or multi-walled), graphene and/or carbon fibers. The introduction of porosity into the carbon material can be achieved by a variety of means. For instance, the porosity in the carbon material can be achieved by modulation of polymer precursors, and/or processing conditions to create said porous carbon material, and described in detail in the subsequent section.

In other embodiments, the porous scaffold comprises a polymer material. To this end, a wide variety of polymers are envisioned in various embodiments to have utility, including, but not limited to, inorganic polymers, organic polymers, and additional polymers. Examples of organic polymers includes, but are not limited to, sulfur-containing polymers such polysulfides and polysulfones, low density polyethylene (LDPE), high density polyethylene (HDPE), polypropylene (PP), polyvinyl chloride (PVC), polystyrene (PS), nylon, nylon 6, nylon 6,6, Teflon® (Polytetrafluoroethylene), thermoplastic polyurethanes (TPU), polyureas, poly(lactide), poly(glycolide) and combinations thereof, phenolic resins, polyamides, polyaramids, polyethylene terephthalate, polychloroprene, polyacrylonitrile, polyaniline, polyimide, poly(3,4-ethylenedioxythiophene) polystyrene sulfonate (PDOT:PSS), polymerized polydivinylbenzene, and others known in the arts. The organic polymer can be synthetic or natural in origin. In some embodiments, the polymer is a polysaccharide, such as sucrose, starch, cellulose, cellobiose, amylose, amylopectin, gum Arabic, lignin, and the like. In some embodiments, the polysaccharide is derived from the caramelization of mono- or oligomeric sugars, such as fructose, glucose, sucrose, maltose, raffinose, and the like.

In certain embodiments, the porous scaffold polymer material comprises a coordination polymer. Coordination polymers in this context include, but are not limited to, metal organic frameworks (MOFs). Techniques for production of MOFs, as well as exemplary species of MOFs, are known and described in the art (“The Chemistry and Applications of Metal-Organic Frameworks, Hiroyasu Furukawa et al. Science 341, (2013); DOI: 10.1126/science.1230444). Examples of MOFs in the context include, but are not limited to, Basolite™ materials and zeolitic imidazolate frameworks (ZIFs).

Concomitant with the myriad variety of polymers envisioned with the potential to provide a porous substrate, various processing approaches are envisioned in various embodiments to achieve said porosity. In this context, general methods for imparting porosity into various materials are myriad, as known in the art, including, but certainly not limited to, methods involving emulsification, micelle creation, gasification, dissolution followed by solvent removal (for example, lyophilization), axial compaction and sintering, gravity sintering, powder rolling and sintering, isostatic compaction and sintering, metal spraying, metal coating and sintering, metal injection molding and sintering, and the like. Other approaches to create a porous polymeric material, including creation of a porous gel, such as a freeze-dried gel, aerogel, and the like are also envisioned.

In certain embodiments, the porous scaffold material comprises a porous ceramic material. In certain embodiments, the porous scaffold material comprises a porous ceramic foam. In this context, general methods for imparting porosity into ceramic materials are varied, as known in the art, including, but certainly not limited to, creation of porous In this context, general methods and materials suitable for comprising the porous ceramic include, but are not limited to, porous aluminum oxide, porous zirconia toughened alumina, porous partially stabilized zirconia, porous alumina, porous sintered silicon carbide, sintered silicon nitride, porous cordierite, porous zirconium oxide, clay-bound silicon carbide, and the like.

In certain embodiments, the porous material comprises a porous metal. Suitable metals in this regard include, but are not limited to porous aluminum, porous steel, porous nickel, porous Inconel®, porous Hastelloy, porous titanium, porous copper, porous brass, porous gold, porous silver, porous germanium, and other metals capable of being formed into porous structures, as known in the art. In some embodiments, the porous scaffold material comprises a porous metal foam. The types of metals and methods to manufacture related to the same are known in the art. Such methods include, but are not limited to, casting (including foaming, infiltration, and lost-foam casting), deposition (chemical and physical), gas-eutectic formation, and powder metallurgy techniques (such as powder sintering, compaction in the presence of a foaming agent, and fiber metallurgy techniques).

### B. Porous Carbon Scaffold Materials

Methods for preparing porous carbon materials from polymer precursors are known in the art. For example, methods for preparation of carbon materials are described in U.S. Pat. Nos. 7,723,262, 8,293,818, 8,404,384, 8,654,507, 8,916,296, 9,269,502, 10,590,277, and 10,711,140, the full disclosures of which are hereby incorporated by reference in their entireties for all purposes.

Accordingly, in one embodiment the present disclosure provides a method for preparing any of the carbon materials or polymer gels described above. The method may be performed by the porous carbon production system 22. The carbon materials may be synthesized through pyrolysis of either a single precursor, for example a saccharide material such as sucrose, fructose, glucose, dextrin, maltodextrin, starch, amylopectin, amylose, lignin, gum Arabic, and other saccharides known in the art, and combinations thereof. Alternatively, the carbon materials may be synthesized through pyrolysis of a complex resin, for instance formed using a sol-gel method using polymer precursors such as phenol, resorcinol, bisphenol A, urea, melamine, and other suitable compounds known in the art, and combinations thereof, in a suitable solvent such as water, ethanol, methanol, and other solvents known in the art, and combinations thereof, with cross-linking agents such as formaldehyde, hexamethylenetetramine, furfural, and other cross-linking agents known in the art, and combinations thereof. The resin may be acid or basic and may contain a catalyst. The catalyst may be volatile or non-volatile. The pyrolysis temperature and dwell time can vary as known in the art.

In some embodiments, the methods comprise preparation of a polymer gel by a sol gel process, condensation process or crosslinking process involving monomer precursor(s) and a crosslinking agent, two existing polymers and a crosslinking agent or a single polymer and a crosslinking agent, followed by pyrolysis of the polymer gel. The polymer gel may be dried (e.g., freeze dried) prior to pyrolysis; however drying is not necessarily required.

The target carbon properties can be derived from a variety of polymer chemistries provided the polymerization reaction produces a resin/polymer with the necessary carbon backbone. Different polymer families include novolacs, resoles, acrylates, styrenes, urethanes, rubbers (neoprenes, styrene-butadienes, etc.), nylons, etc. The preparation of any of these polymer resins can occur via a number of different processes including sol gel, emulsion/suspension, solid state, solution state, melt state, etc. for either polymerization or crosslinking processes.

In some embodiments the reactant comprises phosphorus. In certain other embodiments, the phosphorus is in the form of phosphoric acid. In certain other embodiments, the phosphorus can be in the form of a salt, wherein the anion of the salt comprises one or more phosphate, phosphite, phosphide, hydrogen phosphate, dihydrogen phosphate, hexafluorophosphate, hypophosphite, polyphosphate, or pyrophosphate ions, or combinations thereof. In certain other embodiments, the phosphorus can be in the form of a salt, wherein the cation of the salt comprises one or more phosphonium ions. The non-phosphate containing anion or cation pair for any of the above embodiments can be chosen for those known and described in the art. In the context, exemplary cations to pair with phosphate-containing anions include, but are not limited to, ammonium, tetraethylammonium, and tetramethylammonium ions. In the context, exemplary anions to pair with phosphate-containing cations include, but are not limited to, carbonate, dicarbonate, and acetate ions.

In some embodiments, the reactant comprises sulfur. In certain other embodiments, the sulfur is in the form of sulfuric acid. In certain other embodiments, the sulfur can be in the form of a salt, wherein the anion of the salt comprises one or more sulfate, sulfite, bisulfide, bisulfite, hypothiocyanite, sulfonium, S-methylmethionine, thiocarbonate, thiocyanate, thiophosphate, thiosilicate, or trimethylsulfonium, or combinations thereof.

In some embodiments, the catalyst comprises a basic volatile catalyst. For example, in one embodiment, the basic volatile catalyst comprises ammonium carbonate, ammonium bicarbonate, ammonium acetate, ammonium hydroxide, or combinations thereof. In a further embodiment, the basic volatile catalyst is ammonium carbonate. In another further embodiment, the basic volatile catalyst is ammonium acetate.

In still other embodiments, the method comprises admixing an acid. In certain embodiments, the acid is a solid at room temperature and pressure. In some embodiments, the acid is a liquid at room temperature and pressure. In some embodiments, the acid is a liquid at room temperature and pressure that does not provide dissolution of one or more of the other polymer precursors.

In one embodiment a spherical polydivinylbencene spheres are produced by precipitation polymerization, pyrolyzed, and activated by the methods described herein.

In one embodiment, a porous carbon can be prepared by pyrolysis of a fluorine containing polymer (e.g., polyvinylidenine fluoride) by heating the material to 600° C. under an inert gas such as nitrogen flowing in a horizontal tube furnace. The material was allowed to cool for 30 minutes and subsequently cooled at room departure prior to removing from the furnace. The resulting carbonized material was attrition milled to less than 25-micron particle size distribution and used to prepare electrodes. The porous carbon prepared by this method is rich in fluorine which facilitates formation of lithium fluoride in the initial stage of electrochemical plating of the lithium metal in a lithium-ion battery, thereby increasing the lithiophilicity and reduces detrimental dendrite growth in the battery.

In certain embodiments, the polymer precursor components are blended together and subsequently held for a time and at a temperature sufficient to achieve polymerization. One or more of the polymer precursor components can have particle size less than about 20 mm in size, for example less than 10 mm, for example less than 7 mm, for example, less than 5 mm, for example less than 2 mm, for example less than 1 mm, for example less than 100 microns, for example less than 10 microns. In some embodiments, the particle size of one or more of the polymer precursor components is reduced during the blending process.

The blending of one or more polymer precursor components in the absence of solvent can be accomplished by methods described in the art, for example ball milling, jet milling, Fritsch milling, planetary mixing, and other mixing methodologies for mixing or blending solid particles while controlling the process conditions (e.g., temperature). The mixing or blending process can be accomplished before, during, and/or after (or combinations thereof) incubation at the reaction temperature.

Reaction parameters include aging the blended mixture at a temperature and for a time sufficient for the one or more polymer precursors to react with each other and form a polymer. In this respect, suitable aging temperature ranges from about room temperature to temperatures at or near the melting point of one or more of the polymer precursors. In some embodiments, suitable aging temperature ranges from about room temperature to temperatures at or near the glass transition temperature of one or more of the polymer precursors. For example, in some embodiments the solvent free mixture is aged at temperatures from about 20° C. to about 600° C., for example about 20° C. to about 500° C., for example about 20° C. to about 400° C., for example about 20° C. to about 300° C., for example about 20° C. to about 200° C. In certain embodiments, the solvent free mixture is aged at temperatures from about 50 to about 250° C.

The reaction duration is generally sufficient to allow the polymer precursors to react and form a polymer, for example the mixture may be aged anywhere from 1 hour to 48 hours, or more or less depending on the desired result. Typical embodiments include aging for a period of time ranging from about 2 hours to about 48 hours, for example in some embodiments aging comprises about 12 hours and in other embodiments aging comprises about 4-8 hours (e.g., about 6 hours).

In certain embodiments, an electrochemical modifier is incorporated during the above-described polymerization process performed by the chemical vapor infiltration system 26 for example. For example, in some embodiments, an electrochemical modifier in the form of metal particles, metal paste, metal salt, metal oxide or molten metal can be dissolved or suspended into the mixture from which the gel resin is produced.

Exemplary electrochemical modifiers for producing composite materials may fall into one or more than one of the chemical classifications. In some embodiments, the electrochemical modifier is a lithium salt, for example, but not limited to, lithium fluoride, lithium chloride, lithium carbonate, lithium hydroxide, lithium benzoate, lithium bromide, lithium formate, lithium hexafluorophosphate, lithium iodate, lithium iodide, lithium perchlorate, lithium phosphate, lithium sulfate, lithium tetraborate, lithium tetrafluoroborate, and combinations thereof.

In certain embodiments, the electrochemical modifier comprises a metal, and exemplary species includes, but are not limited to aluminum isopropoxide, manganese acetate, nickel acetate, iron acetate, tin chloride, silicon chloride, and combinations thereof. In certain embodiments, the electrochemical modifier is a phosphate compound, including but not limited to phytic acid, phosphoric acid, ammonium dihydrogen phosphate, and combinations thereof. In certain embodiments, the electrochemical modifier comprises silicon, and exemplary species includes, but are not limited to silicon powders, silicon nanotubes, polycrystalline silicon, nanocrystalline silicon, amorphous silicon, porous silicon, nano sized silicon, nano-featured silicon, nano-sized and nano-featured silicon, silicyne, and black silicon, and combinations thereof.

Electrochemical modifiers can be combined with a variety of polymer systems through either physical mixing or chemical reactions with latent (or secondary) polymer functionality. Examples of latent polymer functionality include, but are not limited to, epoxide groups, unsaturation (double and triple bonds), acid groups, alcohol groups, amine groups, basic groups. Crosslinking with latent functionality can occur via heteroatoms (e.g. vulcanization with sulfur, acid/base/ring opening reactions with phosphoric acid), reactions with organic acids or bases (described above), coordination to transition metals (including but not limited to Ti, Cr, Mn, Fe, Co, Ni, Cu, Zn, Zr, Nb, Mo, Ag, Au), ring opening or ring closing reactions (rotaxanes, spiro compounds, etc.).

Electrochemical modifiers can also be added to the polymer system through physical blending. Physical blending can include but is not limited to melt blending of polymers and/or co-polymers, the inclusion of discrete particles, chemical vapor deposition of the electrochemical modifier and co-precipitation of the electrochemical modifier and the main polymer material.

In some instances, the electrochemical modifier can be added via a metal salt solid, solution, or suspension. The metal salt solid, solution or suspension may comprise acids and/or alcohols to improve solubility of the metal salt. In yet another variation, the polymer gel (either before or after an optional drying step) is contacted with a paste comprising the electrochemical modifier. In yet another variation, the polymer gel (either before or after an optional drying step) is contacted with a metal or metal oxide sol comprising the desired electrochemical modifier.

In addition to the above exemplified electrochemical modifiers, the composite materials may comprise one or more additional forms (i.e., allotropes) of carbon. In this regard, it has been found that inclusion of different allotropes of carbon such as graphite, amorphous carbon, conductive carbon, carbon black, diamond, C60, carbon nanotubes (e.g., single and/or multi-walled), graphene and/or carbon fibers into the composite materials is effective to optimize the electrochemical properties of the composite materials. The various allotropes of carbon can be incorporated into the carbon materials during any stage of the preparation process described herein. For example, during the solution phase, during the gelation phase, during the curing phase, during the pyrolysis phase, during the milling phase, or after milling. In some embodiments, the second carbon form is incorporated into the composite material by adding the second carbon form before or during polymerization of the polymer gel as described in more detail herein. The polymerized polymer gel containing the second carbon form is then processed according to the general techniques described herein to obtain a carbon material containing a second allotrope of carbon.

In some embodiments, the polymer precursor is a polyvinylbenzene spheres produced by precipitation polymerization. In other embodiments, the polymer precursor in the low or essentially solvent free reaction mixture is a urea or an amine containing compound. For example, in some embodiments the polymer precursor is urea, melamine, hexamethylenetetramine (HMT) or combination thereof. Other embodiments include polymer precursors selected from isocyanates or other activated carbonyl compounds such as acid halides and the like.

Some embodiments of the disclosed methods include preparation of low or solvent-free polymer gels (and carbon materials) comprising electrochemical modifiers. Such electrochemical modifiers include, but are not limited to nitrogen, silicon, and sulfur. In other embodiments, the electrochemical modifier comprises fluorine, iron, tin, silicon, nickel, aluminum, zinc, or manganese. The electrochemical modifier can be included in the preparation procedure at any step. For example, in some the electrochemical modifier is admixed with the mixture, the polymer phase or the continuous phase.

The porous carbon material can be achieved via pyrolysis of a polymer produced from precursor materials as described above. In some embodiments, the porous carbon material comprises an amorphous activated carbon that is produced by pyrolysis, physical or chemical activation, or combination thereof in either a single process step or sequential process steps.

The temperature and dwell time of pyrolysis can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the pyrolysis temperature varies from 650° C. to 1100° C. The pyrolysis can be accomplished in an inert gas, for example nitrogen, or argon.

In some embodiments, an alternate gas is used to further accomplish carbon activation. In certain embodiments, pyrolysis and activation are combined. Suitable gases for accomplishing carbon activation include, but are not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the temperature for combined pyrolysis and activation varies from 650° C. to 1100° C.

In some embodiments, combined pyrolysis and activation is carried out to prepare the porous carbon scaffold. In such embodiments, the process gas can remain the same during processing, or the composition of process gas may be varied during processing. In some embodiments, the addition of an activation gas such as CO2, steam, or combination thereof, is added to the process gas following sufficient temperature and time to allow for pyrolysis of the solid carbon precursors.

Suitable gases for accomplishing carbon activation include, but are not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the activation temperature varies from 650° C. to 1100° C.

Either prior to the pyrolysis, and/or after pyrolysis, and/or after activation, the carbon may be subjected to a particle size reduction. The particle size reduction can be accomplished by a variety of techniques known in the art, for example by jet milling in the presence of various gases including air, nitrogen, argon, helium, supercritical steam, and other gases known in the art. Other particle size reduction methods, such as grinding, ball milling, jet milling, water jet milling, and other approaches known in the art are also envisioned.

The porous carbon scaffold may be in the form of particles. The particle size and particle size distribution can be measured by a variety of techniques known in the art and can be described based on fractional volume. In this regard, the Dv50 of the carbon scaffold may be between 10 nm and 10 mm, for example between 100 nm and 1 mm, for example between 1 μm and 100 μm, for example between 2 μm and 50 μm, example between 3 μm and 30 μm, example between 4 μm and 20 μm, example between 5 μm and 10 μm. In certain embodiments, the Dv50 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv100 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv99 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv90 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv0 is greater than 10 nm, for example greater than 100 nm, for example greater than 500 nm, for example greater than 1 μm, for example greater than 2 μm, for example greater than 5 μm, for example greater than 10 μm. In certain embodiments, the Dv1 is greater than 10 nm, for example greater than 100 nm, for example greater than 500 nm, for example greater than 1 μm, for example greater than 2 μm, for example greater than 5 μm, for example greater than 10 μm. In certain embodiments, the Dv10 is greater than 10 nm, for example greater than 100 nm, for example greater than 500 nm, for example greater than 1 μm, for example greater than 2 μm, for example greater than 5 μm, for example greater than 10 μm.

In some embodiments, the surface area of the porous carbon scaffold can comprise a surface area greater than 400 m²/g, for example greater than 500 m²/g, for example greater than 750 m²/g, for example greater than 1000 m²/g, for example greater than 1250 m²/g, for example greater than 1500 m²/g, for example greater than 1750 m²/g, for example greater than 2000 m²/g, for example greater than 2500 m²/g, for example greater than 3000 m²/g. In other embodiments, the surface area of the porous carbon scaffold can be less than 500 m²/g. In some embodiments, the surface area of the porous carbon scaffold is between 200 and 500 m²/g. In some embodiments, the surface area of the porous carbon scaffold is between 100 and 200 m²/g. In some embodiments, the surface area of the porous carbon scaffold is between 50 and 100 m²/g. In some embodiments, the surface area of the porous carbon scaffold is between 10 and 50 m²/g. In some embodiments, the surface area of the porous carbon scaffold can be less than m²/g.

In some embodiments, the pore volume of the porous carbon scaffold is greater than 0.4 cm³/g, for example greater than 0.5 cm³/g, for example greater than 0.6 cm³/g, for example greater than 0.7 cm³/g, for example greater than 0.8 cm³/g, for example greater than 0.9 cm³/g, for example greater than 1.0 cm³/g, for example greater than 1.1 cm³/g, for example greater than 1.2 cm³/g, for example greater than 1.4 cm³/g, for example greater than 1.6 cm³/g, for example greater than 1.8 cm³/g, for example greater than 2.0 cm³/g. In other embodiments, the pore volume of the porous carbon scaffold is less than 0.5 cm³, for example between 0.1 cm³/g and 0.5 cm³/g. In certain other embodiments, the pore volume of the porous carbon scaffold is between 0.01 cm³/g and 0.1 cm³/g.

In some other embodiments, the porous carbon scaffold is an amorphous activated carbon with a pore volume between 0.2 and 2.0 cm³/g. In certain embodiments, the carbon is an amorphous activated carbon with a pore volume between 0.4 and 1.5 cm³/g. In certain embodiments, the carbon is an amorphous activated carbon with a pore volume between 0.5 and 1.2 cm³/g. In certain embodiments, the carbon is an amorphous activated carbon with a pore volume between 0.6 and 1.0 cm³/g.

In some other embodiments, the porous carbon scaffold comprises a tap density of less than 1.0 g/cm³, for example less than 0.8 g/cm³, for example less than 0.6 g/cm³, for example less than 0.5 g/cm³, for example less than 0.4 g/cm³, for example less than 0.3 g/cm³, for example less than 0.2 g/cm³, for example less than 0.1 g/cm³.

The surface functionality of the porous carbon scaffold can vary. One property which can be predictive of surface functionality is the pH of the porous carbon scaffold. The presently disclosed porous carbon scaffolds comprise pH values ranging from less than 1 to about 14, for example less than 5, from 5 to 8 or greater than 8. In some embodiments, the pH of the porous carbon is less than 4, less than 3, less than 2 or even less than 1. In other embodiments, the pH of the porous carbon is between about 5 and 6, between about 6 and 7, between about 7 and 8 or between 8 and 9 or between 9 and 10. In still other embodiments, the pH is high and the pH of the porous carbon ranges is greater than 8, greater than 9, greater than 10, greater than 11, greater than 12, or even greater than 13.

The pore volume distribution of the porous carbon scaffold can vary. For example, the % micropores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable micropore volume in the porous carbon scaffold.

The mesopores comprising the porous carbon scaffold can vary. For example, the % mesopores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable mesopore volume in the porous carbon scaffold.

In some embodiments, the pore volume distribution of the porous carbon scaffold comprises more than 50% macropores, for example more than 60% macropores, for example more than 70% macropores, for example more than 80% macropores, for example more than 90% macropores, for example more than 95% macropores, for example more than 98% macropores, for example more than 99% macropores, for example more than 99.5% macropores, for example more than 99.9% macropores.

In certain preferred embodiments, the pore volume of the porous carbon scaffold comprises a blend of micropores, mesopores, and macropores. Accordingly, in certain embodiments, the porous carbon scaffold comprises 0-20% micropores, 30-70% mesopores, and less than 10% macropores. In certain other embodiments, the porous carbon scaffold comprises 0-20% micropores, 0-20% mesopores, and 70-95% macropores. In certain other embodiments, the porous carbon scaffold comprises 20-50% micropores, 50-80% mesopores, and 0-10% macropores. In certain other embodiments, the porous carbon scaffold comprises 40-60% micropores, 40-60% mesopores, and 0-10% macropores. In certain other embodiments, the porous carbon scaffold comprises 80-95% micropores, 0-10% mesopores, and 0-10% macropores. In certain other embodiments, the porous carbon scaffold comprises 0-10% micropores, 30-50% mesopores, and 50-70% macropores. In certain other embodiments, the porous carbon scaffold comprises 0-10% micropores, 70-80% mesopores, and 0-20% macropores. In certain other embodiments, the porous carbon scaffold comprises 0-20% micropores, 70-95% mesopores, and 0-10% macropores. In certain other embodiments, the porous carbon scaffold comprises 0-10% micropores, 70-95% mesopores, and 0-20% macropores.

In certain embodiments, the % of pore volume in the porous carbon scaffold representing pores between 100 and 1000 A (10 and 100 nm) comprises greater than 30% of the total pore volume, for example greater than 40% of the total pore volume, for example greater than 50% of the total pore volume, for example greater than 60% of the total pore volume, for example greater than 70% of the total pore volume, for example greater than 80% of the total pore volume, for example greater than 90% of the total pore volume, for example greater than 95% of the total pore volume, for example greater than 98% of the total pore volume, for example greater than 99% of the total pore volume, for example greater than 99.5% of the total pore volume, for example greater than 99.9% of the total pore volume.

In certain embodiments, the pycnometry density of the porous carbon scaffold ranges from about 1 g/cc to about 3 g/cc, for example from about 1.5 g/cc to about 2.3 g/cc. In other embodiments, the skeletal density ranges from about 1.5 cc/g to about 1.6 cc/g, from about 1.6 cc/g to about 1.7 cc/g, from about 1.7 cc/g to about 1.8 cc/g, from about 1.8 cc/g to about 1.9 cc/g, from about 1.9 cc/g to about 2.0 cc/g, from about 2.0 cc/g to about 2.1 cc/g, from about 2.1 cc/g to about 2.2 cc/g or from about 2.2 cc/g to about 2.3 cc/g, from about 2.3 cc to about 2.4 cc/g, for example from about 2.4 cc/g to about 2.5 cc/g.

In some embodiments, the carbon scaffold pore volume distribution can be described as the number or volume distribution of pores as determined as known in the art based on gas sorption analysis, for example nitrogen gas sorption analysis. In some embodiments the pore size distribution can be expressed in terms of the pore size at which a certain fraction of the total pore volume resides at or below. For example, the pore size at which 10% of the pores reside at or below can be expressed at DPv10.

The DPv10 for the porous carbon scaffold can vary, for example DPv10 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm.

The DPv50 for the porous carbon scaffold can vary, for example DPv50 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm. In other embodiments, the DPv50 is between 2 and 100, for example between 2 and 50, for example between 2 and 30, for example between 2 and 20, for example between 2 and 15, for example between 2 and 10.

The DPv90 for the porous carbon scaffold can vary, for example DPv90 can be between 0.01 nm and 100 nm, for example between 0.1 nm and 100 nm, for example between 1 nm and 100 nm, for example between 1 nm and 50 nm, for example between 1 nm and 50 nm, for example between 1 nm and 40 nm, for example between 1 nm and 30 nm, for example between 1 nm and 10 nm, for example between 1 nm and 5 nm. In other embodiments, the DPv50 is between 2 nm and 100 nm, for example between 2 nm and 50 nm, for example between 2 nm and 30 nm, for example between 2 nm and 20 nm, for example between 2 nm and 15 nm, for example between 2 nm and 10 nm.

In some embodiments, the DPv90 is less than 100 nm, for example less than 50 nm, for example less than 40 nm, for example less than 30 nm, for example less than 20 nm, for example less than 15 nm, for example less than 10 nm. In some embodiments, the carbon scaffold comprises a pore volume with greater than 70% micropores (and DPv90 less than 100 nm, for example DPv90 less than 50 nm, for example DPv90 less than 40 nm, for example DPv90 less than 30 nm, for example DPv90 less than 20 nm, for example DPv90 less than 15 nm, for example DPv90 less than 10 nm, for example DPv90 less than 5 nm, for example DPv90 less than 4 nm, for example DPv90 less than 3 nm. In other embodiments, the carbon scaffold comprises a pore volume with greater than 80% micropores and DPv90 less than 100 nm, for example DPv90 less than 50 nm, for example DPv90 less than 40 nm, for example DPv90 less than 30 nm, for example DPv90 less than 20 nm, for example DPv90 less than 15 nm, for example DPv90 less than 10 nm, for example DPv90 less than 5 nm, for example DPv90 less than 4 nm, for example DPv90 less than 3 nm.

The DPv99 for the porous carbon scaffold can vary, for example DPv99 can be between 0.01 nm and 1000 nm, for example between 0.1 nm and 1000 nm, for example between 1 nm and 500 nm, for example between 1 nm and 200 nm, for example between 1 nm and 150 nm, for example between 1 nm and 100 nm, for example between 1 nm and 50 nm, for example between 1 nm and 20 nm. In other embodiments, the DPv99 is between 2 nm and 500 nm, for example between 2 nm and 200 nm, for example between 2 nm and 150 nm, for example between 2 nm and 100 nm, for example between 2 nm and 50 nm, for example between 2 nm and 20 nm, for example between 2 nm and 15 nm, for example between 2 nm and 10 nm.

In certain embodiments, the carbon scaffold is modified prior to impregnation of lithium. For example, in certain embodiments, the surface of the carbon pores is functionalized for the purpose of creating a more lithiophilic surface, i.e., surface that interacts preferentially with lithium or lithium containing precursor materials, wherein said preferential interaction can manifest as preferential diffusion, deposition, adsorption of the like.

In some embodiments metal oxides are used to functionalize the porous carbon and improve lithiophilicity and thereby improve SEI stability of a lithium metal anode. In this embodiment, a porous carbon scaffold is modified with zinc oxide via a hydrothermal sol-gel synthesis reaction. Zinc acetate dihydrate is dissolved in water and stirred with micronized porous carbon powder. A strong oxidizing agent such as NaOH is then added dropwise into the reaction solution and allowed to react for up to 2 hours, before being separated by filtration and allowed to dry. In some embodiments the metal oxide may be aluminum oxide, nickel oxide, manganese oxide, cobalt oxide, tin oxide, or titanium oxide.

In still further embodiments the metal oxide is deposited via atomic layer deposition, physical vapor deposition onto the porous carbon surface and then subsequently converted to a metal oxide via chemical or thermal oxidation reactions. In still further embodiments, the porous carbon may be coated with a polymer containing lithium.

C. Introduction of Silicon into Scaffold Materials to Create Composite Materials

Nano-sized silicon is difficult to handle and to process in traditional electrodes. Due to the high surface area and preference to agglomerate, uniform dispersion and coating requires special procedures and/or binder systems. To truly be a drop-in replacement for existing graphite anode materials, the next generation Si—C material needs to be micron-sized. In a preferred embodiment, the size distribution for the composite is relatively uniform, with upper and lower bounds within a preferred range, for example, Dv10 of no less than 5 nm, a Dv50 between 500 nm and 5 μm, and a Dv90 no greater than 50 μm. In certain embodiments, the composite particles are comprised of the following size distribution: Dv10 of no less than 50 nm, a Dv50 between 1 μm and 10 μm, and a Dv90 no greater than 30 μm. In certain other embodiments, the composite particles are comprised of the following size distribution: Dv10 of no less than 100 nm, a Dv50 between 2 μm and 8 μm, and a Dv90 no greater than 20 μm. In certain further embodiments, the composite particles are comprised of the following size distribution: Dv10 of no less than 250 nm, a Dv50 between 4 μm and 6 μm, and a Dv90 no greater than 15 μm.

Unlike existing composite materials which bury silicon into a mass of inactive material, it is understood that to achieve optimal performance, silicon needs room to expand and contract. In certain embodiments high pore volume carbons serve as porous scaffolds in which to embed or deposit silicon, and do so in an engineered fashion, filling pore volume of desired range to create impregnated carbon material of the desired size range. Thus, the scaffold, for example the porous carbon material, plays an important role as a framework and engineered in-situ control for expansion and contraction of the material as well as contributing to the overall electron and ion conduction capability of the composite particle. This scaffold structure allows for the movement of electrons and ions. The primary role of the scaffold is to a framework to affix the silicon to a single location and volume, allowing the silicon to outwardly expand and contract while remaining lodged inside the pores of the carbon scaffold material.

In certain embodiments, the silicon is introduced into the porous carbon by nanoparticle impregnation by the chemical vapor infiltration system 26 of FIG. 1. Accordingly, a nano-sized or nano-sized and nano-featured silicon is first produced. In a preferred embodiment, the nano-sized and nano-featured silicon (individually or collectively “nano silicon”) is produced according to methods described in U.S. Pat. No. 10,147,950 “Materials With Extremely Durable Intercalation Of Lithium And Manufacturing Methods Thereof,” and/or U.S. Pat. No. 11,611,073 “Composites of Porous Nano-Featured Silicon Materials and Carbon Materials,” the full disclosures of which are hereby incorporated by reference in their entireties for all purposes.

The porous carbon can be mixed with the nano silicon, for example in a stirred reactor vessel wherein the carbon particles, for example micro sized porous carbon particles, are co-suspended with nano silicon of the desired particle size. The suspension milieu can be varied as known in the art, for example can be aqueous or non-aqueous. In certain embodiments, the suspension fluid can be multi-component, comprising either miscible or non-miscible co-solvents. Suitable co-solvents for aqueous (water) milieu include, but are not limited to, acetone, ethanol, methanol, and others known in the art. A wide variety of non-water soluble milieu are also known in the art, including, but not limited to, heptane, hexane, cyclohexane, oils, such as mineral oils, vegetable oils, and the like. Without being bound by theory, mixing within the reactor vessel allows for diffusion of the silicon nanoparticles within the porous carbon particle. The resulting nano silicon impregnated carbon particles can then be harvested, for example, by centrifugation, filtration, and subsequent drying, all as known in the art.

To this end, the porous carbon particles with the desired extent and type of porosity are subject to processing that results in creation of silicon within said porosity. For this processing, the porous carbon particles can be first particle size reduced, for example to provide a Dv50 between 1 and 1000 microns, for example between 1 and 100 microns, for example between 1 and 50 microns, for example between 1 and 20 microns, for example between 1 and 15 microns, for example between 2 and 12 microns, for example between 5 and 10 microns. The particle size reduction can be carried out as known in the art, and as described elsewhere herein, for instance by jet milling.

In a preferred embodiment, silicon is created within the pores of the porous carbon by subjecting the porous carbon particles to silane gas at elevated temperature and the presence of a silicon-containing gas, preferably silane, in order to achieve silicon deposition via chemical vapor deposition (CVD). The silane gas can be mixed with other inert gases, for example, nitrogen gas. The temperature and time of processing can be varied, for example the temperature can be between 300 and 400° C., for example between 40° and 500° C., for example between 50° and 600° C., for example between 60° and 700° C., for example between 700 and 800° C., for example between 800 and 900° C. The mixture of gas can comprise between 0.1 and 1% silane and remainder inert gas. Alternatively, the mixture of gas can comprise between 1% and 10% silane and remainder inert gas. Alternatively, the mixture of gas can comprise between 10% and 20% silane and remainder inert gas. Alternatively, the mixture of gas can comprise between 20% and 50% silane and remainder inert gas. Alternatively, the mixture of gas can comprise above 50% silane and remainder inert gas. Alternatively, the gas can essentially be 100% silane gas. The reactor in which the CVD process is carried out is according to various designs as known in the art, for example in a fluid bed reactor, a static bed reactor, an elevator kiln, a rotary kiln, a box kiln, or other suitable reactor type. The reactor materials are suitable for this task, as known in the art. In a preferred embodiment, the porous carbon particles are processed under conditions that provide uniform access to the gas phase, for example a reactor wherein the porous carbon particles are fluidized, or otherwise agitated to provide said uniform gas access.

In some embodiments, the CVD process is a plasma-enhanced chemical vapor deposition (PECVD) process. This process is known in the art to provide utility for depositing thin films from a gas state (vapor) to a solid state on a substrate. Chemical reactions are involved in the process, which occur after creation of a plasma of the reacting gases. The plasma is generally created by RF (AC) frequency or DC discharge between two electrodes, the space between which is filled with the reacting gases. In certain embodiments, the PECVD process is utilized for porous carbon that is coated on a substrate suitable for the purpose, for example a copper foil substrate. The PECVD can be carried out at various temperatures, for example between 30° and 800° C., for example between 300 and 600° C., for example between 300 and 500° C., for example between 300 and 400° C., for example at 350° C. The power can be varied, for example 25W RF, and the silane gas flow required for processing car be varied, and the processing time can be varied as known in the art.

The silicon that is impregnated into the porous carbon, regardless of the process, is envisioned to have certain properties that are optimal for utility as an energy storage material. For example, the size and shape of the silicon can be varied accordingly to match, while not being bound by theory, the extent and nature of the pore volume within the porous carbon particle. For example, the silicon can be impregnated, deposited by CVD, or other appropriate process into pores within the porous carbon particle comprising pore sizes between 5 nm and 1000 nm, for example between 10 nm and 500 nm, for example between 10 nm and 200 nm, for example between 10 nm and 100 nm, for example between 33 nm and 150 nm, for example between 20 nm and 100 nm. Other ranges of carbon pores sizes with regards to fractional pore volume, whether micropores, mesopores, or macropores, are also envisioned as described elsewhere within this disclosure.

The oxygen content in silicon can be less than 50%, for example, less than 30%, for example less than 20%, for example less than 15%, for example, less than 10%, for example, less than 5%, for example, less than 1%, for example less than 0.1%. In certain embodiments, the oxygen content in the silicon is between 1 and 30%. In certain embodiments, the oxygen content in the silicon is between 1 and 20%. In certain embodiments, the oxygen content in the silicon is between 1 and 10%. In certain embodiments, the oxygen content in the porous silicon materials is between 5 and 10%.

In certain embodiments wherein the silicon contains oxygen, the oxygen is incorporated such that the silicon exists as a mixture of silicon and silicon oxides of the general formula SiOx, where X is a non-integer (real number) can vary continuously from 0.01 to 2. In certain embodiments, the fraction of oxygen present on the surface of the nano-feature porous silicon is higher compared to the interior of the particle.

In certain embodiments, the silicon comprises crystalline silicon. In certain embodiments, the silicon comprises polycrystalline silicon. In certain embodiments, the silicon comprises micro-polycrystalline silicon. In certain embodiments, the silicon comprises nano-polycrystalline silicon. In certain other embodiments, the silicon comprises amorphous silicon. In certain other embodiments, the silicon comprises both crystalline and non-crystalline silicon.

In certain embodiments, the carbon scaffold to be impregnated or otherwise embedded with silicon can comprise various carbon allotropes and/or geometries. To this end, the carbon scaffold to be impregnated or otherwise embedded with silicon can comprise graphite, nano graphite, graphene, nano graphene, conductive carbon such as carbon black, carbon nanowires, carbon nanotubes, and the like, and combinations thereof.

In certain embodiments, the carbon scaffold that is impregnated or otherwise embedded with silicon is removed to yield the templated silicon material with desired size characteristics. The removal of the scaffold carbon can be achieved as known in the art, for example by thermal of chemical activation under conditions wherein the silicon does not undergo undesirable changes in its electrochemical properties. Alternatively, if the scaffold is a porous polymer or other material soluble in a suitable solvent, the scaffold can be removed by dissolution.

### D. Gas Analysis

In various embodiments, systems and methods are provided for performing chemical vapor infiltration (CVI) reaction endpoint determination. An end of a CVI reaction is determined to consistently produce a porous carbon with infiltrated silicon material with repeatable physical properties in a high-throughput environment.

### 1. 3 Gas Analyzer

In various embodiments, as shown in FIG. 1, a system 20 is provided for determining status of a reaction, such as the CVI process described above, performed by a reactor 22. The reactor 22 includes a heating device 24 and possibly other motor-controlled components that are controlled by a controller 26. The system 20 includes a processor 30 that is in signal communication with the controller 26, a first gas meter 36, a gas density meter 38, a user interface device 32, and an output device 34. The first gas meter 36 measures concentration of a first gas at an exit port 28 of the reactor 22. The first gas meter 36 may be a hydrogen gas meter, such as HY-ALERTA™ 2620 produced by H2scan. The gas density meter 38 measures the density of all gases at the exit port 28. A Coriolis meter is an example of a gas density meter.

In various embodiments, the user interface device 32 may be any device that allows a user to specify input values. The user interface device 32 may be a graphical user interface 32 with data entry fields. The user interface device 32 may be presented on a display device (e.g., the output device 34).

In various embodiments, the output device 34 may be any device that provides an indication that may be interpreted by a human operator. For example, the output device 34 may be a display, lights, speakers, and/or tactile devices.

In various embodiments, the system 20 determines rate of change of hydrogen percentage or concentration, then identifies end of reaction (i.e., target silane usage) based on the H rate of change and a predefined pore volume of the porous activated carbon inputted.

In various embodiments, the processor 30 receives a concentration value for hydrogen from the gas concentration meter 36 and a gas density value from the gas density meter 38, an inert gas flow rate value from the user interface 32, and an initial density value from the gas density meter 38 taken before starting the reactor 22. The inert gas may be nitrogen, argon, helium, or other inert gases. The processor 30 calculates a density time interval average and a hydrogen (H₂) time interval average from the gas density meter 38 and first gas meter 32, respectively. The processor 30 then calculates a molecular weight value based on the initial density value and the density time interval average, see example eq. (1) below:

$$MW = [ \frac{{D}_{ave} - ( min \cdot current [ I ] \times shunt resistance [ ohm ] )}{\begin{matrix}( max current \times shunt resistance [ ohm ] ) - \\ ( min current [ I ] \times shunt resistance [ ohm ] )\end{matrix}} \times ( max signal - min signal ) ] + min current [ I ] - {I}_{D} \qquad ( 1 )$$

Dₐᵥₑ—density time interval average,
I_{D}—initial density.

The processor 30 then calculates nitrogen (N₂) concentration based on the calculated mole weight (MW). Eq. (2) below is an example equation for calculating nitrogen concentration:

$$N \% = \frac{( MW silane - MW ) - {H}_{2} \% \times ( ( MW {SiH}_{4} - MW {H}_{2} ) / 100 )}{( MW {SiH}_{4} - MW {N}_{2} )} \times 100 \qquad ( 2 )$$

The processor 30 then calculates silane (SiH₄)% (% of silane used during reaction with carbon materials within the reactor 22) using eq. (3), (4) below:

$${SiH}_{4} \% = 1 - {H}_{2} \% - {N}_{2} \% \qquad ( 3 )$$

$$1 = {m}_{H 2} + {m}_{SiH 4} + {m}_{N 2.} \qquad ( 4 )$$

The processor 30 performs the calculations described above at a predefined time interval (e.g., 1, 2, 5, 10 seconds, or other intervals). The processor 30 compares the calculated SiH₄% to a predefined SiH₄% threshold value. If the processor 30 determines that SiH₄% is at or above the SiH₄% threshold value, the processor 30 may output a completion signal to the output device 34 and/or the controller 26. In response to receiving the completion signal, the output device 34 outputs a visual, an audible, and/or a tactile indication for an operator to receive. In addition to or alternatively, the controller 26 will deactivate the reactor 22 by turning off the heating device 24 or control other components of the reactor 22 in response to receiving the completion signal.

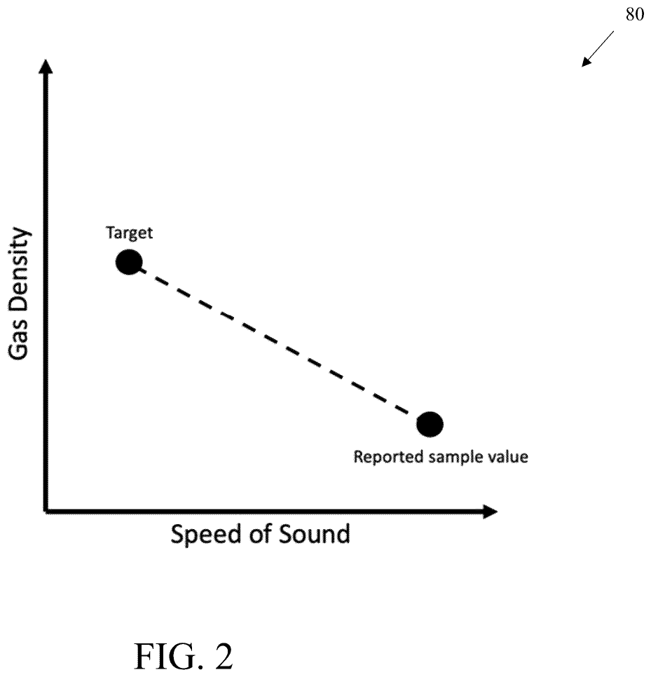

Referring to FIG. 2, a graph 80 illustrates that using the speed of sound and gas density one can identify the concentration of three gases in a mixture where one gas is inert. One can estimate the concentration of the desired reactant A, by-product C, to estimate the product B deposition rate with an inert N.

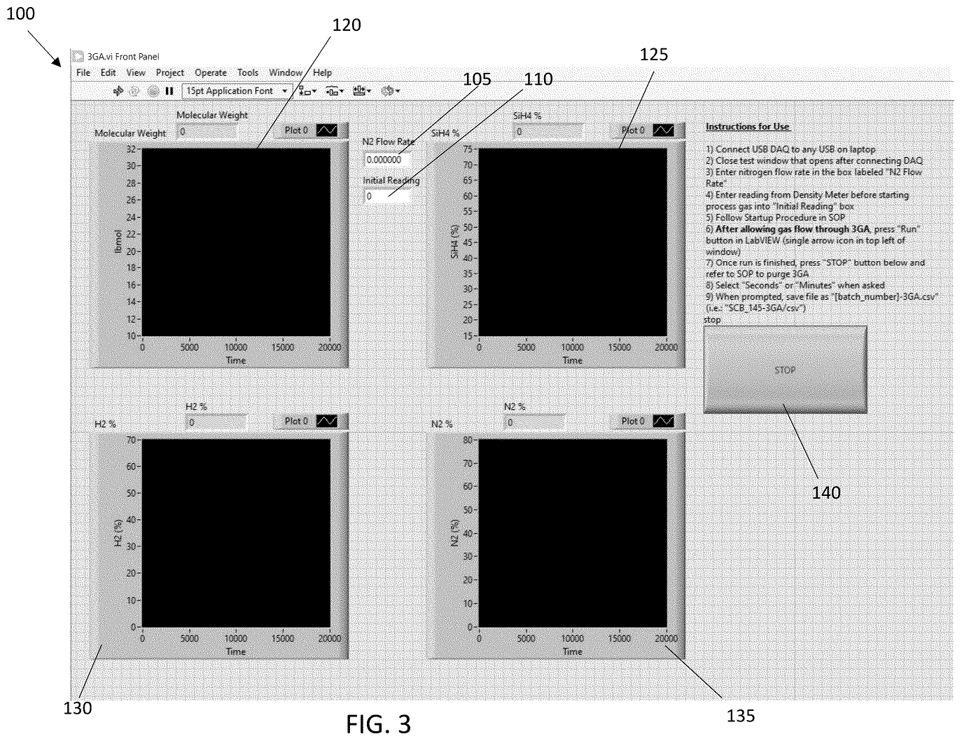

Referring to FIG. 3, a graphical user interface (GUI) 100 presented on the display output device 34 includes a field 105 for allowing a user to enter the N₂ flow rate and a field 110 for receiving an initial density value. The processor 30 using the calculations above generates a molecular weight graph 120, an H₂% graph 130, an N₂% graph 135, and a SiH₄% graph 125. The GUI 100 includes a stop button 140 that when activated by a user (via touchscreen or cursor activated) results in production of a deactivation signal for the reactor 22. The user would activate the stop button 140 upon the SiH₄% graph 125 showing acceptable SiH₄ absorption. As described above, automatic deactivation of the reactor 22 may be performed by the processor 30 upon the SiH₄% reaching acceptable an SiH₄ absorption level.

### 2. Binary Gas Analyzer

In various embodiments, a binary gas analysis (BGA), which relies on measuring the speed of sound through an ideal gas media, is performed. Differences in density, temperature, and heat capacity allow for differentiation of ideal gases by speed of sound. Using these factors, a binary gas analyzer can accurately determine molar concentrations of mixtures containing two ideal gases. This method for analysis allows for accurate real time process monitoring and endpoint determination of silane deposition/infiltration by measuring silane and hydrogen content in the exhaust stream(s) of a reactor.

A measured utilization value is a maximum utilization (UH) and a calculated minimum utilization for silane that decomposes into 2 hydrogen molecules (UL), as seen below. Where mSiH₄ is the measured mol % of silane in the exhaust stream

$${U}_{H} = 1 - {m}_{SiH 4}$$

$${U}_{L} = \frac{1 - {m}_{SiH 4}}{1 + {m}_{SiH 4}}$$

A weighted utilization calculation is based on the percentage of silane that decomposes via each decomposition path. The weighted utilization is used to determine silicon loading. In the following equation, b is the percent of silane that decomposes into 2 moles of hydrogen:

$${U}_{W} = {bU}_{L} + ( 1 - b ) {U}_{H}$$

The value for b can then be experimentally determined by adjusting b until calculated silicon loading equals measured silicon loading.

In various embodiments, a gas sensor is queried for primary gas % once every so many seconds (e.g., 1, 2, 5, 10 seconds, or other intervals) in the scenario where the inputs to the reactor 22 are just porous carbon and SiH₄. The primary gas % is collected from the BGA which relies on acoustic resonance to determine gas concentration. The primary gas % value is transformed into a silane utilization % (SiH₄%) by removing the gas sensor's programmed offset, described below, and subtracting the result from 100. The silane utilization % is then converted to mass of silicon deposited using the ideal gas law, inlet flow rate, and a sampling interval. The mass of silicon deposited is converted to weight % by dividing silicon mass by the total mass of carbon and silicon added. The rate of change of the weight % of silicon is then used to notify that the reaction has been run to a target point (i.e., in-spec product).

The processor 30 may also be configured to perform binary gas analysis. The processor generates an indication when an ideal endpoint condition has been met which ensures that the in-spec product is reliably made every time. This process limits material over-coating and decreases overhead cost by reducing total process gas use. It can be appreciated by one of ordinary skill in the art that this method can be applied to any CVI process for improving output repeatability.

Using the ideal gas law flow rate and utilization are converted to moles of silane decomposed. The moles of silane decomposed is then used to calculate grams of silicon deposited per minute. The processor 30 integrates grams of silicon deposited per minute using a trapezoidal method to calculate the hypothetical total mass of silicon deposited. The processor uses total mass of deposited silicon to calculate the hypothetical wt % of the finished product.

Speed of sound in a mixture of ideal gases can be expressed as the following equation:

$$W = \sqrt{\frac{( {m}_{1} {γ}_{1} + {m}_{2} {γ}_{2} ) RT}{{m}_{1} {M}_{1} + {m}_{2} {M}_{2}}}$$

Where:
W=Speed of sound
R=Ideal gas constant
T=Temperature (K)
M=Molar mass
γ=Adiabatic Index (Cp/Cv)
m=Mole percent as decimal.

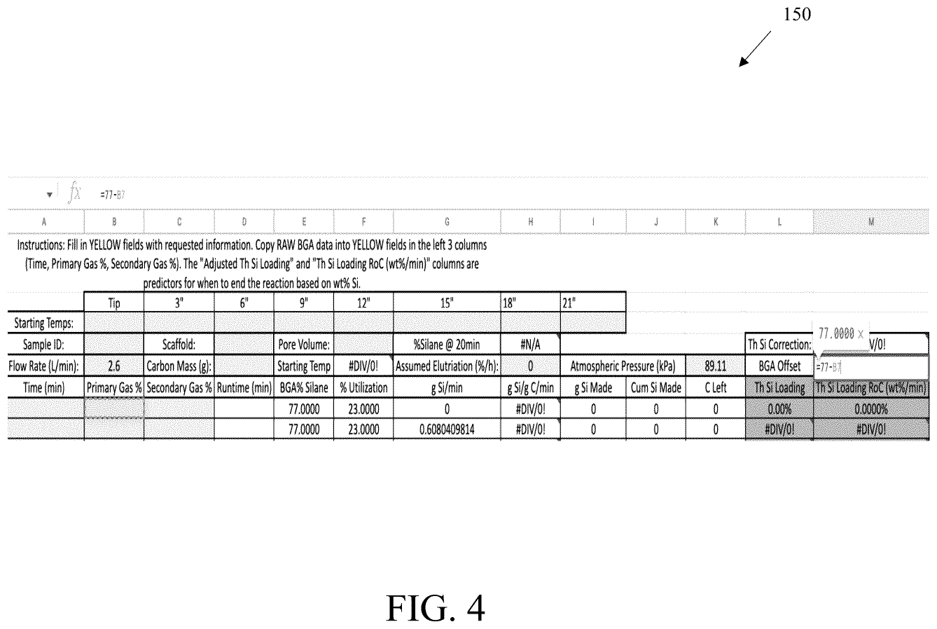

The above-described process performed by the processor 30 may be implemented manually or with aid of a spreadsheet, such as a BGA log 150, as shown in FIG. 4. A user enters a starting temperature(s), scaffold, pore volumes, silane flow rate (L/min), carbon mass (g), assumed elutriation (%/h), atmospheric pressure (kPa), time, primary gas %, and secondary gas %. Based on the entered information, the processor 30, via algorithms embedded into the BGA log 150, generates BGA % silane, % utilization, g Si/min, g Si/g C/min, g Si made, cumulative Si made, C remaining, theoretical wt % Si loaded vs time. BGA % silane refers to the unreacted silane gas measured by the instrument. % utilization refers to the silane being consumed during the reaction.

Since the BGA log 150 reports gases as mol %, the BGA log 150 first converts supplied volume of silane per minute to grams of silane per minute using the ideal gas law and molar mass of silicon in column G:

$$g Si / min - ( PV / RT ) * M$$

Since pressure (P) can vary, local atmospheric pressure (kPa) is used. The reactor flow rate is used for the volume of supplied gas per minute (V). Temperature (T) is approximated to 22° C. (295.15K). R is the ideal gas constant approximated to 8.314 kPa*L/mol*K. The molar mass (M) of silicon is approximated as 28 g/mol.

BGA % Silane is the reported primary gas % from the BGA log 150 with the offset removed. In column E, a user checks if a starting value of BGA % silane is 77. Since the BGA has been programmed to look for silane in hydrogen gas mixture, the presence of a different gas will create an offset in the initial measured value. In this case, reactions are started under a nitrogen atmosphere which causes an offset of 77%. If the starting value isn't 77, the offset calculated in cell M3 to set the starting value to 77. Because the BGA log 150 uses a flat offset, the same correction is applied to all data points to put the % secondary gas in a range.

The primary gas % from the BGA log 150 is first used in column E, where the programmed offset is removed and the starting primary gas % is set to 77%. The % utilization is calculated as 100−(BGA % Silane) in column F.

g Si supplied/min*(% utilization/100)≅g Si deposited/min

Column G reports the theoretical grams of silicon deposited per minute based on % utilization. This number will be used to determine the theoretical final silicon loading.

In column I, grams of silicon deposited per minute is combined with current runtime to integrate the g Si/min vs runtime curve and find the total amount of silicon added during the time interval using trapezoidal integration.

In column J, the individual segments are added together to determine the total amount of silicon deposited since the beginning of the run.

In column L, the current theoretical wt % of loaded silicon is calculated with the formula: theoretical grams of Si added/(theoretical grams of Si added+grams of C present).

In cell M4, the expected % error is calculated from the starting temperature of the reactor. This relationship is based on experimental data (bottom right) that shows the % error between theoretical wt % Si (in column L) and measured wt % Si is a function of starting reactor temperature when reactor temperatures are not changed during the run.

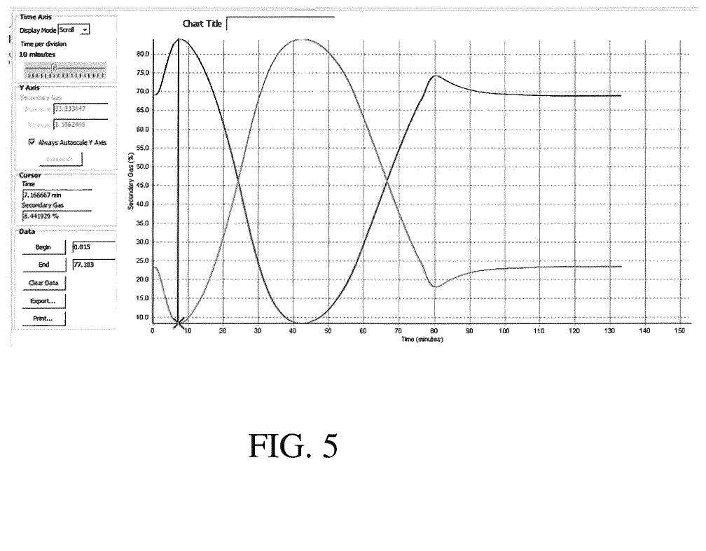

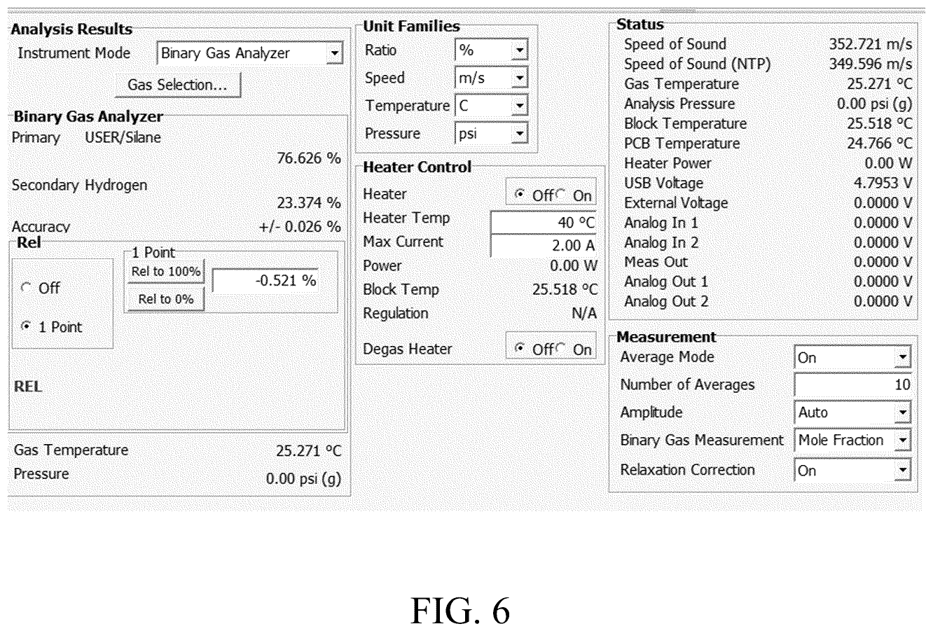

An operator of the reactor 22 reads the results produced by the BGA log 150. The results may be presented in a stripchart (see example in FIG. 5), a snapshot screen (see example in FIG. 6), or directly off the displayed BGA log 150.

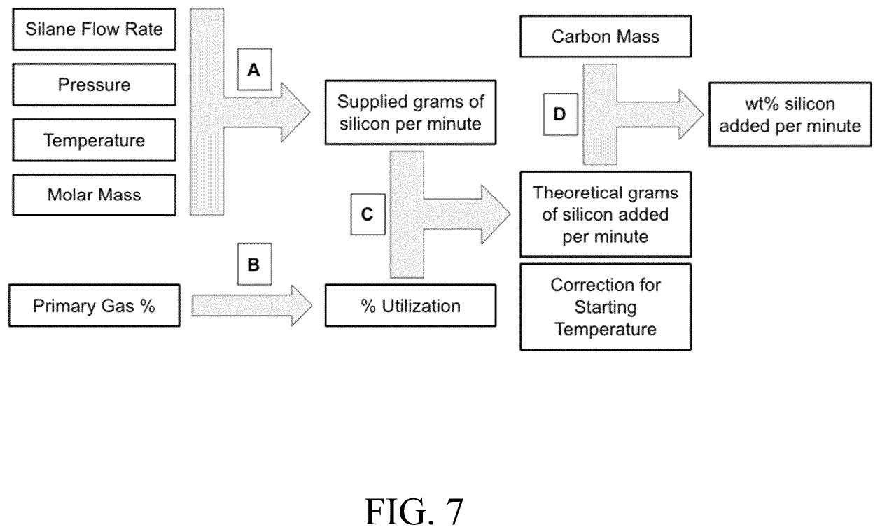

FIG. 7 illustrates process steps executed with respect to the BGA log 150 as described above.

In a mixture of 2 gases, the observed v (i.e., W) becomes:

$$v = \sqrt{\frac{{γ}_{mix} RT}{{M}_{mix}}}$$

such that:

$${M}_{mix} = \frac{{n}_{1} {M}_{1} + {n}_{2} {M}_{2}}{{n}_{1} + {n}_{2}} \qquad {γ}_{mix} = \frac{{C}_{P , mix}}{{C}_{V , mix}}$$

where:

$${C}_{V , mix} = \frac{{n}_{1} {C}_{V , 1} + {n}_{2} {C}_{V , 2}}{{n}_{1} + {n}_{2}} \qquad {C}_{P , mix} = \frac{{n}_{1} {C}_{P , 1} + {n}_{2} {C}_{P , 2}}{{n}_{1} + {n}_{2}}$$

resulting in the final equation:

$$W = \sqrt{\frac{\frac{{n}_{1} {C}_{p , 1} + {n}_{2} {C}_{p , 2}}{{n}_{1} {C}_{v , 1} + {n}_{2} {C}_{v , 2}} * RT}{\frac{{n}_{1} {M}_{1} + {n}_{2} {M}_{2}}{{n}_{1} + {n}_{2}}}}$$

where n₁ and n₂ are the moles of each gas.

### Zeroing the BGA and Relative Offset

When the BGA is zeroed, the user is manually telling the instrument the mole percent of the primary gas present for the measured speed of sound (SoS). This SoS becomes W. Every second, the BGA measures the SoS currently present (WO) and divides it by the original measurement to calculate the current values of n1,0 and n2,0. Because this is effectively measuring the rate of change of both gases, zeroing the BGA acts as a flat offset for the data. No matter what the BGA is zeroed to, the rate of change between measurements will remain constant.

### EXPRESSED EMBODIMENTS

Embodiment 1. A method comprising receiving a value of a quantity of an inert gas sent to a reactor, receiving a hydrogen concentration value sensed at a first exhaust of the reactor, receiving a total density value sensed at a second exhaust of the reactor, determining a silicon absorption value based on the value of the quantity of the inert gas, the hydrogen concentration value, and the total density value, and outputting a process completion indication in response to the silicon absorption value being at or above a predetermined threshold value.

Embodiment 2. The method of the foregoing Embodiment, wherein the inert gas is nitrogen.

Embodiment 3. The method of the foregoing Embodiments, wherein the threshold value is greater than 30%.

Embodiment 4. The method of the foregoing Embodiments, wherein the first exhaust is the same as the second exhaust.

Embodiment 5. The method of the foregoing Embodiments, wherein outputting the process completion indication comprises outputting a visual indication, a tactile indication, or an audible indication.

Embodiment 6. The method of Embodiment 5, wherein outputting the visual indication comprises activating a light.

Embodiment 7. The method of Embodiment 5 or 6, wherein outputting the visual indication comprises a changing a presented graphical user interface.

Embodiment 8. The method of the foregoing Embodiments, further comprising automatically deactivating the reactor in response to the process completion indication.

Embodiment 9. A system comprising a user interface device configured to allow a user to enter a value of a quantity of an inert gas an inert gas quantity inputted to a reactor, an output device, a hydrogen sensor configured to generate a hydrogen concentration value sensed at a first exhaust of the reactor, a total density sensor configured to generate a total density value sensed at a second exhaust of the reactor, and a processor coupled to the user interface device, the output device, the hydrogen sensor, and the total density sensor. The processor is configured to receive the value of the quantity of the inert gas, the hydrogen concentration value, and the total density value, determine a silicon absorption value based on the value of the quantity of the inert gas, the hydrogen concentration value, and the total density value, generate a signal in response to the silicon absorption value being at or above a predetermined threshold value, and send the generated signal to the output device. The output device outputs an indication in response to receiving the signal.

Embodiment 10. The system of the foregoing Embodiment, wherein the inert gas is nitrogen.

Embodiment 11. The system of the foregoing Embodiments, wherein the threshold value is greater than 30%.

Embodiment 12. The system of the foregoing Embodiments, wherein the first exhaust is the same as the second exhaust.

Embodiment 13. The system of the foregoing Embodiments, wherein the output device is configured to output a visual indication, a tactile indication, or an audible indication.

Embodiment 14. The system of the foregoing Embodiments, wherein the visual indication comprises an activated light.

Embodiment 15. The system of the foregoing Embodiments, wherein the visual indication comprises a change of a presented graphical user interface.

Embodiment 16. The system of the foregoing Embodiments, further the processor is further configured to send the generated signal to a controller of the reactor.

Embodiment 17. A reactor comprising a chamber including an exhaust, the chamber is configured to: receive an inert gas, silane, and a porous carbon material and heat the received the inert gas, the silane, and the porous carbon material, a user interface device configured to allow a user to enter an inert gas quantity inputted to the chamber, an output device, a hydrogen sensor configured to generate a hydrogen concentration value sensed at the exhaust of the chamber, a total density sensor configured to generate a total density value sensed at a second exhaust of the chamber, and a processor coupled to the user interface device, the output device, the hydrogen sensor, and the total density sensor, the processor being configured to: receive the entered inert gas quantity, the hydrogen concentration value, and the total density value, determine a silicon absorption value based on the received inert gas quantity, the hydrogen concentration value, and the total density value, generate a signal in response to the silicon absorption value being at or above a predetermined threshold value, and sending the generated signal to the output device. The output device outputs an indication in response to receiving the signal.

Embodiment 18. The reactor of the foregoing Embodiment, further comprising a controller configured to control chamber operations, wherein the controller is configured to: receive the generated signal and automatically stop heating operations in response to the received signal.

Embodiment 19. The reactor of the foregoing Embodiments, wherein the inert gas is nitrogen.

Embodiment 20. The reactor of the foregoing Embodiments, wherein the output device is configured to output a visual indication, a tactile indication, or an audible indication.

From the foregoing it will be appreciated that, although specific embodiments of the disclosure have been described herein for purposes of illustration, various modifications may be made without deviating from the spirit and scope of the disclosure.

1. A method comprising:
receiving a value of a quantity of an inert gas sent to a reactor;
receiving a hydrogen concentration value sensed at a first exhaust of the reactor;
receiving a total density value sensed at a second exhaust of the reactor;
determining a silicon absorption value based on the value of the quantity of the inert gas, the hydrogen concentration value, and the total density value; and
outputting a process completion indication in response to the silicon absorption value being at or above a predetermined threshold value.

2. The method of claim 1, wherein the inert gas is nitrogen.

3. The method of claim 1, wherein the threshold value is greater than 30%.

4. The method of claim 1, wherein the first exhaust is the same as the second exhaust.

5. The method of claim 1, wherein outputting the process completion indication comprises outputting a visual indication, a tactile indication, or an audible indication.

6. The method of claim 5, wherein outputting the visual indication comprises activating a light.

7. The method of claim 5, wherein outputting the visual indication comprises a changing a presented graphical user interface.

8. The method of claim 1, further comprising automatically deactivating the reactor in response to the process completion indication.

9. A system comprising:
a user interface device configured to allow a user to enter a value of a quantity of an inert gas an inert gas quantity inputted to a reactor;
an output device;
a hydrogen sensor configured to generate a hydrogen concentration value sensed at a first exhaust of the reactor;
a total density sensor configured to generate a total density value sensed at a second exhaust of the reactor; and
a processor coupled to the user interface device, the output device, the hydrogen sensor, and the total density sensor, the processor being configured to:
receive the value of the quantity of the inert gas, the hydrogen concentration value, and the total density value;
determine a silicon absorption value based on the value of the quantity of the inert gas, the hydrogen concentration value, and the total density value;
generate a signal in response to the silicon absorption value being at or above a predetermined threshold value; and
send the generated signal to the output device,
wherein the output device outputs an indication in response to receiving the signal.

10. The system of claim 9, wherein the inert gas is nitrogen.

11. The system of claim 9, wherein the threshold value is greater than 30%.

12. The system of claim 9, wherein the first exhaust is the same as the second exhaust.

13. The system of claim 9, wherein the output device is configured to output a visual indication, a tactile indication, or an audible indication.

14. The system of claim 12, wherein the visual indication comprises an activated light.

15. The system of claim 12, wherein the visual indication comprises a change of a presented graphical user interface.

16. The system of claim 12, further the processor is further configured to send the generated signal to a controller of the reactor.

17. A reactor comprising:
a chamber including an exhaust, the chamber is configured to:
receive an inert gas, silane, and a porous carbon material; and
heat the received the inert gas, the silane, and the porous carbon material;
a user interface device configured to allow a user to enter an inert gas quantity inputted to the chamber;
an output device;
a hydrogen sensor configured to generate a hydrogen concentration value sensed at the exhaust of the chamber;
a total density sensor configured to generate a total density value sensed at a second exhaust of the chamber; and
a processor coupled to the user interface device, the output device, the hydrogen sensor, and the total density sensor, the processor being configured to:
receive the entered inert gas quantity, the hydrogen concentration value, and the total density value;
determine a silicon absorption value based on the received inert gas quantity, the hydrogen concentration value, and the total density value;
generate a signal in response to the silicon absorption value being at or above a predetermined threshold value; and
sending the generated signal to the output device,
wherein the output device outputs an indication in response to receiving the signal.

18. The reactor of claim 17, further comprising a controller configured to control chamber operations, wherein the controller is configured to:
receive the generated signal; and
automatically stop heating operations in response to the received signal.

19. The reactor of claim 17, wherein the inert gas is nitrogen.

20. The reactor of claim 17, wherein the output device is configured to output a visual indication, a tactile indication, or an audible indication.
